(19) United States
(12) Patent Application Publication
(10) Pub. No.: US 2009/0181136 A1
(43) Pub. Date: Jul. 16, 2009

(54) Method for Sealing a Package and a Package

(75) Inventors: Heli Vesanto, Tampere (FI); Paivi Maatta, Imatra (FI); Tapani Penttinen, Huutjarvi (FI); Marjo Elorae, Tampere (FI); Tapio Hietaranta, Vantaa (FI); Risto Vesanto, Imatra (FI); Pentti Jarvela, Lahti (FI)

Correspondence Address: BIRCH STEWART KOLASCH & BIRCH, PO BOX 747, FALLS CHURCH, VA, 22040-0747, US

(73) Assignee: Stora Enso Oyj, Helsinki (FI)

(21) Appl. No.: 12/225,803

(22) PCT Filed: Mar. 31, 2007
(86) PCT No.: PCT/IB2007/000848

§ 371 Date: Apr. 3, 2009

(30) Foreign Application Priority Data
Mar. 31, 2006 (FI) 20060319

(51) Int. Cl. A23L 1/48; B29C 45/14; B65D 41/32

(52) U.S. Cl. 426/122; 264/263; 426/392; 220/265

(57) ABSTRACT

The invention relates to a method for sealing a package (1) containing a product (4), wherein the lid portion (3) and the bottom portion (2) of the package are joined together by means of plastic material. The bottom portion (2) and the lid portion (3) are joined together by sealing by injection molding, by molding plastic material (5) on both sides of a joint (10) between the bottom portion and the lid portion in such a way that the plastic material (5) exteriorly covers the joint (10) on the outside and joins the bottom portion (2) and the lid portion (3) together.

### FIELD OF THE INVENTION

The invention relates to a method for sealing a package, in which a lid portion and a bottom portion are joined together by means of plastic material. The invention also relates to a package comprising a bottom portion and a lid portion joined to it by means of plastic material.

### BACKGROUND OF THE INVENTION

Good sealing is required of food packages; that is, they must be impermeable to gas, moisture and, depending on the quality of the food, also grease; in other words, the package materials used for the package must have good barrier properties. The materials are often based on cardboard, comprising plastic or metal layers to enhance the barrier properties. Food-containing packages normally have a structure with a bottom portion containing the packed food and a lid portion joined to the bottom portion. Such a food package is normally a package to be sold in a retail shop and to be opened by the buyer when the food is used. The food can be either heated in the package, depending on the suitability of the package, or the food can be removed from it and be prepared separately to palatable condition. At some stage of using the food, the lid portion is removed from the bottom portion when the package is opened to access the food. It is very common to use heat-sealable plastic materials to join the lid portion to the bottom portion.

Examples of food packages and package materials used therein are mentioned, for example, in documents WO 03/033258, EP 1 289 856, WO 00/21854, and U.S. Pat. No. 5,425,972.

It has been known for a long time that the joint between the bottom portion and the lid portion is the most critical point in the food package, because, on one hand, it must be tightly sealable and it must not impair the general barrier properties of the package, but on the other hand, the package should be relatively easy to open later on. Furthermore, the sealing of the package should be easily included in the industrial process of packaging the food. International publication WO 03/078012 discloses a package in which the bottom portion and the lid portion, which enclose a packed food, are joined by means of plastic material added to the rim of the bottom portion. The plastic material is added by injection molding to the rim of the bottom portion, wherein the material can be utilized for attaching the lid by heat sealing or mechanically. Here, another function of the plastic material is to reinforce the rim of the package. Depending on the packaging process, however, material (splash etc.) from the substance to be packed may be left between the lid and the bottom portion, impairing the quality of the joint. Furthermore, in the case of heat sealing, the material of the lid and the plastic to be injection molded at the rim of the bottom portion must be compatible with each other.

### BRIEF SUMMARY OF THE INVENTION

It is an aim of the invention to present a method for food packaging that provides very good sealing at said joint and that is applicable in an industrial food packaging process. Another aim of the invention is to present a package that has good impermeability also at the joint between the bottom portion and the lid portion and that does not put restrictions on the structure of the package materials. To achieve this aim, the method according to the invention is primarily characterized in that the bottom portion and the lid portion are joined to each other by molding plastic material on both sides of the joint between the bottom portion and the lid portion in such a way that the plastic material covers the joint on the outside and secures the bottom portion and the lid portion together. The method can be implemented, for example, by suitable thermoplastics of food grade, and in practice, the molding can be implemented, for example, by injection molding.

Because the connection is made primarily or solely by means of molded plastic material to join the portions together outside the joint (at the outer edge of the interface between the lower surface of the lid portion and the upper surface of the rim of the bottom portion that lie against each other), the materials in contact can be selected more freely, for example to optimize the barrier properties, and they do not necessarily need to be heat-sealable to each other.

During the molding, it is also possible to take into account, for example, the openability of the package so that the plastic material surrounding the joint is provided with a weakening, for example a recess towards the center of the package, and/or an interface between the flow fronts that have met. The weakening can also be provided in the rim of the bottom portion, inside the plastic material.

The plastic material used for the sealing is selected according to the conditions of transportation, storage, sales and use of the package. Heat-resistance can be taken into account, if the closed package is intended to be heated, for example, in a microwave oven, or the requirements of storage temperatures can be considered, if the package is intended to be stored, for example, in frozen state. The plastic material may be a polymeric material suitable for injection molding, for example some thermoplastic or thermoelastic. What is essential is that it can be molded in liquid or flowing state onto the edges of the closed package, and solidified to a form that joins the lid portion and the bottom portion tightly together.

Compared with the method presented in WO 03/078012, the method of sealing by injection molding according to the invention has the advantage that the process does not involve any extra molding step. Both the injection molding and the closing of the lid are performed at the same work stage. The bottom portions, such as trays or cups or other vessels intended for storing products, as well as the lids, can be manufactured as before. In fact, the variety of package materials used for them becomes wider, because heat-sealability is not a decisive factor.

### BRIEF DESCRIPTION OF THE DRAWINGS

In the following, the invention will be described in more detail with reference to the following drawings, in which

FIG. 1 shows a closed package according to the invention in a cross-section,

FIG. 2 shows another type of a closed package in a cross-section,

FIG. 3 shows the joint between the lid portion and the bottom portion according to a first embodiment,

FIG. 4 shows the joint between the lid portion and the bottom portion according to a second embodiment,

FIG. 5 shows the joint between the lid portion and the bottom portion according to a third embodiment, and

FIG. 6 shows schematically the steps of sealing the package according to the invention, and

FIG. 7 shows schematically the steps of sealing according to an alternative embodiment.

### DESCRIPTION OF THE PREFERRED EMBODIMENTS

FIG. 1 shows a food package 1 that has been closed tightly, which means impermeability to at least gas and water vapour. The general structure of the package is such that it comprises a bottom portion 2 forming the bottom of a container for food 4 packed in the package. This bottom portion comprises a bottom as well as side walls extending upwards from the bottom, their rims ending at a horizontal flange 2a encircling the edges of the bottom portion. Such a package is normally called a tray package. On top of the bottom portion 2, a lid portion 3 is placed, which in the case shown in FIG. 1 is a planar straight cover whose edges are placed on top of the flange 2a. The area in which the lower surface of the lid portion 3 and the upper surface of the flange 2a are against each other, is called a joint, and it is indicated with reference numeral 10.

In this context, food refers to any food intended to be consumed by people or animals.

The material of both the bottom portion 2 and the lid 3 may be cardboard or paper based material. When cardboard or paper based package material is used, it may be dispersion, sol gel or extrusion coated, or thermally coated, or coated by another suitable method, or totally uncoated. Coating materials may include polymeric materials or pigment based materials. In the package, also laser-markable materials can be used. The center of the lid portion 3 may be provided with a window made of a transparent material.

Particularly in paper or paperboard based package materials for food, the coating layers must act as barrier layers, to prevent, on one hand, the leaking out of substances from the food through the package material and, on the other hand, the entry of substances into the package from the outside. Such materials added on the outer and/or inner surface by any of the above-mentioned methods may be known barrier materials which may consist of polymer but also of metal.

It is also possible that the bottom portion 2 and the lid portion 3 of the package 1 consist fully of plastic. The lid portion 3 may consist of, for example, transparent plastic.

In the material that forms the bottom portion 2 and the lid portion 3, it can also be taken into account that it is suitable for either a MAP package (Modified Atmosphere Packaging) or for treatment in an autoclave. In the package material, it is also possible to take into account the conditions of transportation, storage, sales and use (suitability for freezing and/or suitability for microwave oven, for example a so-called ovenable tray).

However, in the coatings of the package material, it is not necessary to take into account the sealability of the lid portion 3 and the bottom portion 2 together, thanks to the joining method which will be discussed further below. Consequently, the inner coatings of the lid portion 3 and the bottom portion 2 may be non-heat-sealable, and they may be selected in view of the functionality of the package, for example according to good barrier properties.

The bottom portion 2 and the lid portion 3 joined together enclose an air-tight inner compartment in which the food 4 is packed and which may also comprise a suitable gas composition, if it is a MAP package. The seam 10 formed by the lower surface of the lid portion 3 and the upper surface of the flange 2a encircling the bottom portion 2 is closed exteriorly by injection molded plastic material 5 which encircles the whole package in the horizontal plane. Thus, the horizontal joint 10, which has previously formed a problem point in view of the sealing of the package, is at each side covered with plastic material 5 which prevents mass transfer from the inside out of the package and from the outside in through the joint 10. The plastic material covers fully both the outer edge of the bottom portion 2 (the flange 2a) and the outer edge of the lid portion 3, which do not have any protective layers but the paper or paperboard material is exposed. Thus, the plastic material 5 preferably extends also to the upper surface of the lid portion 3 and the lower surface of the flange 2a. Thus, the plastic material 5 can be fixed firmly at the joint, and it also has a stiffening effect. After the edge of the plastic material 5, the upper surface of the lid portion 3 extends bare towards the middle of the package. Similarly, on the lower side after the edge of the plastic material 5, the lower surface of the flange 2a extends bare towards the middle of the package. On the lower side of the flange 2a, the plastic material 5 ends before the side wall of the bottom portion 2.

Because the opposite surfaces of the lid portion 3 and the bottom portion 2 are joined by means of the plastic material 5 present at their edges, there is no need to use sealable polymeric materials on the actual surfaces. For example, the inner coatings of the paperboard or paper based bottom portion 2 and lid portion 3 can thus be selected more freely, or the package materials used in them may even be uncoated. In paperboard or paper based package materials, it is also possible to use coatings which are not heat-sealable to each other, for example coatings selected particularly on the basis of the barrier properties. Similarly, the opposite surfaces of the bottom portion 2 and the lid portion 3 do not need to be completely smooth, but for example the flange 2a encircling the bottom portion 2 may be allowed to have unevenness that is for example typical of tray packages due to their shaping. Furthermore, substances occasionally ended up between said surfaces, such as splashes possibly formed during packaging of the food 4, do not impair the tightness, because they do not affect the material joining the portions together which is now placed outside said surfaces in the form of plastic material 5 sealing the joint on the outside.

In other respects, the package 2 can be provided with normal printing on the bottom portion 2 and/or the lid portion 3.

The injection molded plastic material may be suitable polymeric material, such as thermoplastic or thermoelastic. Examples of suitable polymers include polyolefins, polyesters and polyamides. The plastic material may also be modified in view of this use. It is also possible that the plastic material to be injection molded is dyed in a suitable way to improve the appearance of the package. Furthermore, it is possible to use a plastic blend for the molding, or to form the molded rim encircling the package of two components by so-called multicomponent injection molding.

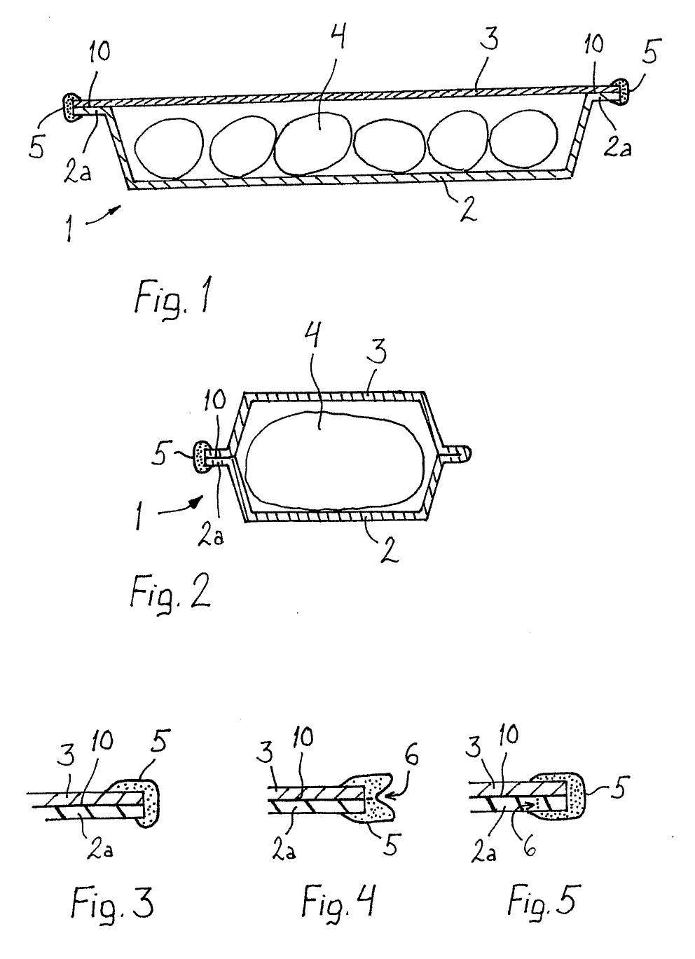

FIG. 2 shows another type of a package, in which the difference to the package of FIG. 1 is that while the lid 3 in the package of FIG. 1 continues in the direction of the plane of the flange 2a over the centre of the vessel-like bottom portion 2 of the package, the lid 3 in FIG. 2 is above the plane of the flange 2a at the centre of the bottom portion 2. In FIG. 2, both the bottom portion 2 and the lid portion 3 are vessel-like in the same way as the bottom portion 2 in FIG. 1, their flanges being placed against each other. Furthermore, the package is a so-called hinged package in which the bottom portion 2 and the lid portion 3 are integrated on one side; in other words, there is no joint extending to the outer edge in this section. Also here, the joint 10 extending to the outer edge is covered on the outside with plastic material 5 which, by injection molding, forms a rim encircling the package at least along the length of the joint. At the hinge, the portions are integrated in each other, and the package is thus inherently closed, and consequently the plastic material rim is not necessarily needed in this section. The material options for both the package materials and the molded plastic material are the same as above.

In FIGS. 1 and 2, the joint 10 is straight and ends in the cut edges of blanks forming the lid 3 and the bottom portion 2. When the blanks are made of coated cardboard, the plastic material 5 thus forms also a shield for the so-called untrimmed edge.

FIGS. 3 to 5 show how the package 1 can be made easily openable in spite of the plastic material 5 tightly sealing the joint 10 between the lid portion 3 and the bottom portion 2. In FIG. 3, the plastic material 5 extends closer to the outer edge of the package on the side of the flange 2a of the bottom portion than above the lid portion 3. Thus, the joint can be broken by bending the joint upwards. Because the plastic material 5 has a smaller contact area with the flange 2a (the lower surface of the flange) than with the lid portion 3 (the upper surface of the lid portion), it can be easily detached from the flange 2a, and the lid can be opened. The plastic material 5 remains attached to the lid portion 3. Because the lid portion 3 and the bottom portion 2 are not glued to each other in the area of the joint 10, it is easy to open the lid once the seal formed by the plastic material 5 has been broken.

In FIG. 4, a weakening 6 has been made at the outer edge of the plastic material 5, approximately at the height of the joint 10 between the lid portion and the bottom portion. The weakening has here the shape of a recess extending towards the middle of the package. The cover can be opened at the recess in the plastic material by bending the upper half of the plastic material 5. If the rim formed by the plastic material 5 is molded simultaneously from two directions by using the same plastic material, the flow fronts formed by different material inputs and emerging from opposite directions can be brought to join approximately at the height of the joint 10, wherein a kind of an interface is formed inside the material which produces a weakening (broken line) in the mechanical sense but does not impair the impermeability.

FIG. 5 shows a structure which facilitates the opening, wherein the weakening 6 is not in the plastic material 5 which now extends equally far towards the middle of the package both above the lid portion 3 and below the flange 2a. The weakening is made in the package material itself, in this case in the flange 2a of the bottom portion 2, so that it extends around the package inside the edge of the plastic material 5. By bending the edge of the package upwards at the plastic material 5, the flange 2a is broken at the weakening, and the cover can be opened.

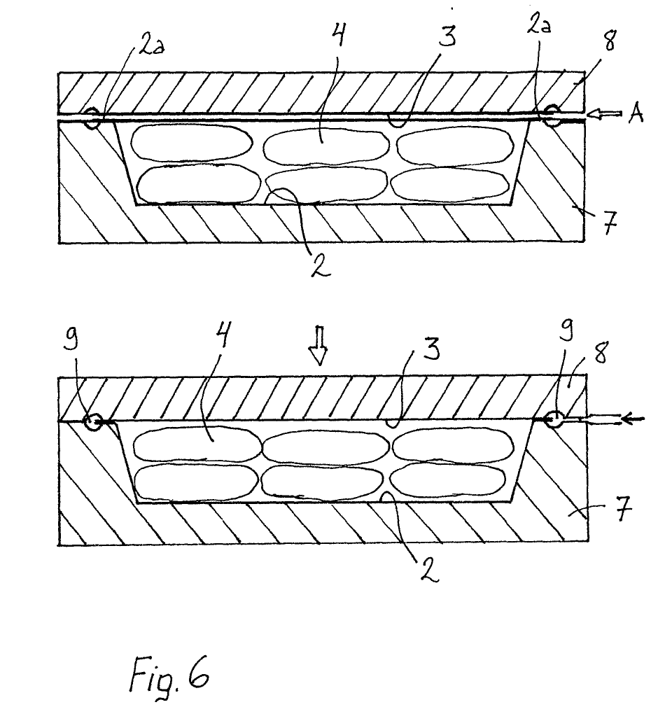

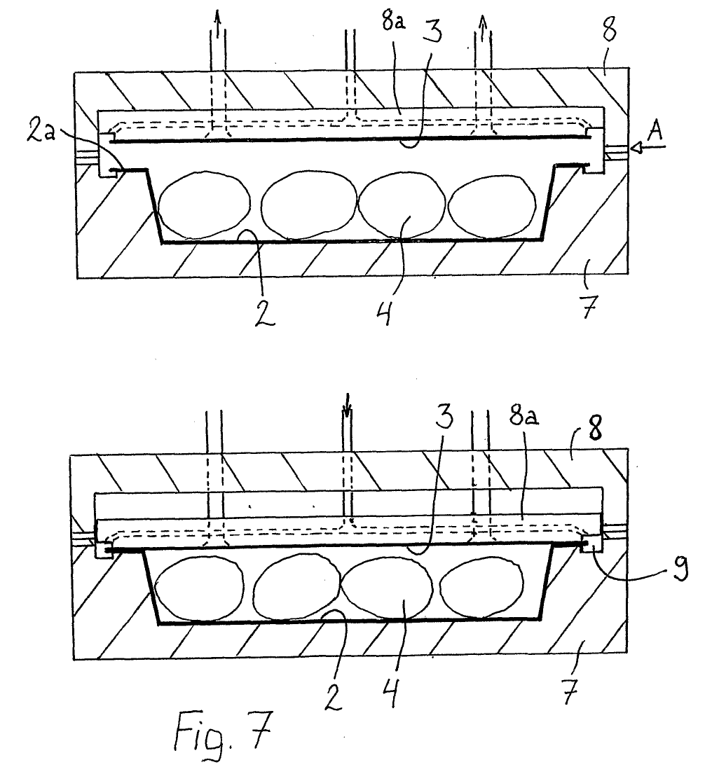

FIG. 6 shows the steps of sealing the package in a schematic view. In the first step, the food 4 is placed in the bottom portion 2 of the package, and the bottom portion 2 and the lid portion 3 are separate, the first-mentioned in a lower mold half 7 and the latter held by an upper mold half 8. The lid portion may be sucked, for example by a vacuum, onto the lower surface of the upper mold half 8. At this stage, a protective gas or another gas composition suitable for the inside of the package can be blown from between the flange 2a and the lid portion 3 into the package so that it is flushed by the gas (arrow A). After this, the mold halves 7, 8 are brought together so that a mold cavity 9 is formed at the outer edge of the flange 2a of the bottom portion and the outer edge of the flange of the lid portion 3, encircling the package along the length of the joint 10 in the horizontal direction. This mold cavity determines the location and shape of the rim formed of the injection molded material. The material is molded by feeding molten or flowing polymer along feed channels extending through the upper mold half 8 into the mold cavity, and after the material has solidified, it forms the solid plastic material 5 sealing the joint 10 in the above-described manner.

It is also possible to close the mold in such a way that the lid is not yet closed. FIG. 7 shows an arrangement in which the mold comprises an inner piece 8a arranged to be movable in the closing direction and having vacuum channels for holding the lid 3 and feed channels for the material to be molded. The upper mold half 8 also comprises separate suction and feed channels for the vacuum and for feeding the gas composition, respectively. In the first figure, an inner piece 8a is in the upper position, and a vacuum is formed in the mold by suction, after which the desired gas composition is fed by means of said channels. After this, the lid 3 is closed by pressing the inner piece 8a down, wherein it simultaneously covers the suction and feeding channels, and the rim is injection molded as above.

Consequently, by the sealing method according to the invention, it is possible to secure that the gas composition (e.g. protective gas) fed into the package remains in the package, thanks to the hermetical sealing of the joint.

The steps shown in FIGS. 6 and 7 can be easily integrated in the rest of the automated packaging process. The injection mold (mold halves) shown in FIGS. 6 and 7 may be in a carousel-type device with several similar molds, of which one at a time receives the package, and after going through different steps, delivers the sealed package for further processing.

The packages may also have other shapes than those in FIGS. 1 and 2 above. The package may also be beaker-shaped, a package with a circular or quadrangular horizontal cross-section, in which the height to width ratio is greater than in tray packages; that is, a so-called cup.

The package materials of the bottom portion 2 and the lid portion 3 may also be based on different materials; for example, the bottom portion may be based on paper or paperboard and the lid portion may consist of plastic or metal foil; the bottom portion may consist of plastic and the lid portion may be based on paper or paperboard or metal foil; or the bottom portion may consist of metal foil and the lid portion may be based on paper or paperboard or of plastic. This is possible particularly because the sealing technique allows for more combinations for packaging foods, without affecting the impermeability.

Also, it is insignificant if the food enclosed in the package is solid, liquid, dry, moisture-containing, etc.

Even though the sealing of food packages has been described above, the invention can also be used for the sealing of packages containing other products. Thus, the package material may also be selected more freely, for example wood or metal. Such products are not necessarily easily perishable, and they may be, for example, textiles, small iron goods, office supplies, or other products for wholesale or retail trade. In such packages, the sealing by injection molding may be provided on most part of the outer edge of the lid and the bottom portion, and the part with no such sealing may be equipped with a structure facilitating the opening. In particular, the invention is suitable for the packaging of such flowing nonfood products which may leak out of the joint. Furthermore, the above-described sealing by injection molding can be used for the package of such products which are not foods but which must not lose their moisture or other substances which may evaporate from the product into the environment.

1-15. (canceled)

16. A method for sealing a package containing a product, comprising
providing a lid portion made of package material and a bottom portion made of package material;
placing the product in the bottom portion;
placing the lid portion on top of the bottom portion so that a joint is formed between the lid portion and the bottom portion;
molding plastic material on both sides of said joint in such a way that the plastic material covers the joint exteriorly and joins the bottom portion and the lid portion together.

17. The method according to claim 16, wherein the plastic material is molded in such a way that it encircles an edge of the bottom portion and an edge of the lid portion, extending onto an upper surface of the package material of the lid portion and onto a lower surface of the package material of the bottom portion. I

18. The method according to claim 16, wherein the plastic material is thermoplastic or thermoelastic.

19. The method according to claim 17, wherein, to facilitate opening of the package, the molding is performed in such a way that
a mechanical weakening of any of the following type is formed in the plastic material: a recess, an internal interface formed by different flow fronts, or unequal contact areas of the plastic material with the lid portion and the bottom portion; or
a weakening made in the package material of the bottom portion close to its outer edge remains inside the molded plastic material.

20. The method according to claim 18, wherein, to facilitate opening of the package, the molding is performed in such a way that
a mechanical weakening of any of the following type is formed in the plastic material: a recess, an internal interface formed by different flow fronts, or unequal contact areas of the plastic material with the lid portion and the bottom portion; or
a weakening made in the package material of the bottom portion close to its outer edge remains inside the molded plastic material.

21. The method according to claim 16, wherein the method comprises:
placing the product in the bottom portion,
placing the bottom portion and the lid portion in an injection mold,
closing the injection mold in such a way that the lid portion and the bottom portion come against each other,
molding the plastic material at an outer edge of the bottom portion and the lid portion to form a sealed package,
opening the injection mold, and
removing the sealed package from the injection mold.

22. The method according to claim 19, wherein the method comprises:
placing the product in the bottom portion,
placing the bottom portion and the lid portion in an injection mold,
closing the injection mold in such a way that the lid portion and the bottom portion come against each other,
molding the plastic material at an outer edge of the bottom portion and the lid portion to form a sealed package,
opening the injection mold, and
removing the sealed package from the injection mold.

23. The method according to claim 22, comprising
feeding gas from between the lid portion and the bottom portion.

24. The method according to claim 19, wherein a package that contains food is sealed.

25. The method according to claim 22, wherein a package that contains food is sealed.

26. The method according to claim 23, wherein a package that contains food is sealed.

27. A package comprising a bottom portion made of package material and a lid portion made of package material and a product packed in an inner space defined by them, the bottom portion and the lid portion being joined together by means of plastic material molded on both sides of a joint between the bottom portion and the lid portion, covering exteriorly the joint and joining the bottom portion and the lid portion together.

28. The package according to claim 27, wherein the plastic material encircles an edge of the bottom portion and the lid portion, and extends onto an upper surface of the package material of the lid portion and onto a lower surface of the package material of the bottom portion.

29. The package according to claim 27, wherein the bottom portion comprises a bottom, side walls extending upwards from the bottom, and a flange adjoining the side walls, the lid portion being placed on top of the flange.

30. The package according to claim 27, wherein the plastic material is technical thermoplastic or thermoelastic.

31. The package according to claim 28, wherein an edge of the package comprises a mechanical weakening to facilitate the opening of the package in any of the following ways:
a recess formed in the plastic material, an internal interface formed in the plastic material by different flow fronts, or unequal contact areas of the plastic material with the lid portion and the bottom portion; or
in the package material of the bottom portion a weakening close to its outer edge and situated inside the molded plastic material (5).

32. The package according to claim 28, wherein the plastic material encircles an outer edge of the package along the whole length of the joint.

33. The package according to claim 28, wherein the joint consists of an interface between opposite surfaces of the lid portion and the bottom portion placed against each other, where the opposite surfaces are separate from each other and joined by the plastic material on the outside.

34. The package according to claim 31, wherein the joint consists of an interface between opposite surfaces of the lid portion and the bottom portion placed against each other, where the opposite surfaces are separate from each other and joined by the plastic material on the outside.

35. The package according to claim 27, wherein the package material forming the lid portion and the bottom portion is of the following groups:
paper or paperboard based materials,
plastics,
metal foils,
wherein the materials of the lid portion and the bottom portion may belong to the same group or different groups.

36. The package according to claim 28, wherein the packed product is food.

37. The package according to claim 31, wherein the packed product is food.
